(19) United States
(12) Patent Application Publication
(10) Pub. No.: US 2017/0262146 A1
(43) Pub. Date: Sep. 14, 2017

(54) ELECTRONIC RECORD INFORMATION DISPLAYING APPARATUS AND METHOD

(71) Applicant: FUJITSU LIMITED, Kawasaki-shi (JP)

(72) Inventor: Shogo SHIMURA, Kawasaki (JP)

(73) Assignee: FUJITSU LIMITED, Kawasaki-shi (JP)

(21) Appl. No.: 15/442,105

(22) Filed: Feb. 24, 2017

(30) Foreign Application Priority Data
Mar. 14, 2016 (JP) 2016-049116

(51) Int. Cl. G06F 3/0483; G06F 17/21

(52) U.S. Cl. CPC G06F 3/0483; G06F 17/212; G06F 3/04883

(57) ABSTRACT

An electronic record information displaying apparatus includes a display unit, and a control unit configured to cause the display unit to display a first display area that displays an edge image corresponding to an edge of document and a second display area that displays an image of a first page corresponding to a specific position designated to the edge image.

### CROSS-REFERENCE TO RELATED APPLICATION

This application is based upon and claims the benefit of priority of the prior Japanese Patent Application No. 2016-049116, filed on Mar. 14, 2016, the entire contents of which are incorporated herein by reference.

### FIELD

The embodiments discussed herein are related to an electronic record information displaying apparatus and method.

### BACKGROUND

A smart phone, a tablet terminal, etc. are used to a variety of purposes in addition to speech communication and Web reading.

For example, the smart phone and the tablet terminal may be used as a handwriting notebook. For example, through an OCR (Optical Card Reader), information described on each page of the notebook may be acquired as data, so that the acquired data is stored into the smart phone as a handwriting notebook. Alternatively, a user may input a memorandum etc. into the smart phone, so as to store information such as the memorandum as a handwriting notebook. The user can use such a handwriting notebook for a variety of purposes, including generating a document and an electronic mail.

As an example, there is a technology as follows: An apparatus and a method for displaying and searching an electronic book in which, by the use of count value video data which visually represents the count value of a number of display times of a document video, a count value video is displayed in an associative manner with a document video. It is urged that, according to the above technology, the visual representation of the number of times of page reference enables an easy document search.

Also, there is a method for displaying an image in which, when a fore edge or a tail edge of one spread image is pointed, a spread preview image which includes the pointed page is displayed, and when the preview image is pointed, another spread image associated with the preview image is displayed. It is urged that, according to the above technology, it is easy to open a target page as a result of a jump from the one spread page to the other page.

### PRIOR TECHNICAL DOCUMENTS

### Patent Documents

[Patent document 1] Japanese Laid-open Patent Publication No. 06-337896.

[Patent document 2] Japanese Laid-open Patent Publication No. 2010-39757.

However, for example, there may be a case that a user searches a handwriting notebook for a target page, or information described on the target page, relying on a vague memory. In such a case, for example, the user executes a search by relying on such a vague memory as “that which I wrote around that part of the notebook”, “that which I wrote slightly after that page”, and so on, or in short, with a sense of “around that part” of the notebook.

In the above-mentioned technologies, for example, an edge part is visually displayed in association with the number of display times, or a preview image of a spread page including a pointed page is displayed. There may be cases that, even when using such technologies, a user executes a search by relying on a vague memory with a sense of “around that part” of the notebook. If a page obtained by the search with the vague memory is not a desired page, the user executes a search again by relying on the vague memory. In such a search, it may take a long time before the user finds out the desired page, or the search of the target page may result in a failure. Or, in some cases, the vague memory itself is wrong, in which the user may become unable to identify where the desired page is located, resulting in a search failure.

### SUMMARY

According to an aspect of the embodiments, an electronic record information displaying apparatus includes a display unit, and a control unit configured to cause the display unit to display a first display area that displays an edge image corresponding to an edge of document and a second display area that displays an image of a first page corresponding to a specific position designated to the edge image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of an electronic record information displaying apparatus.

FIG. 2 is a diagram illustrating a configuration example of an electronic record information displaying apparatus.

FIGS. 3A and 3B are diagrams illustrating examples of a display screen and features, respectively.

FIG. 4 is a diagram illustrating an example of a book.

FIG. 5 is a diagram illustrating an example of handwriting notebooks.

FIG. 6 is a diagram illustrating an example of an edge UI.

FIG. 7 is a flowchart illustrating an example of display operation of an edge UI.

FIG. 8 is a flowchart illustrating an example of display operation corresponding to a user operation.

FIGS. 9A and 9B are diagrams illustrating display screen examples.

FIG. 10 is a diagram illustrating a configuration example of an electronic record information displaying apparatus.

FIG. 11 is a diagram illustrating a configuration example of an electronic record information displaying apparatus.

FIGS. 12A and 12B are diagrams illustrating examples of a display screen and features, respectively.

FIGS. 13A and 13B are diagrams illustrating examples of a display screen and features, respectively.

### DESCRIPTION OF EMBODIMENTS

Hereinafter, the embodiments of the present invention will be described. The embodiments are not aimed to limit the disclosed technology. Further, each embodiment can appropriately be combined within a range of not producing contradiction among processing contents.

### First Embodiment

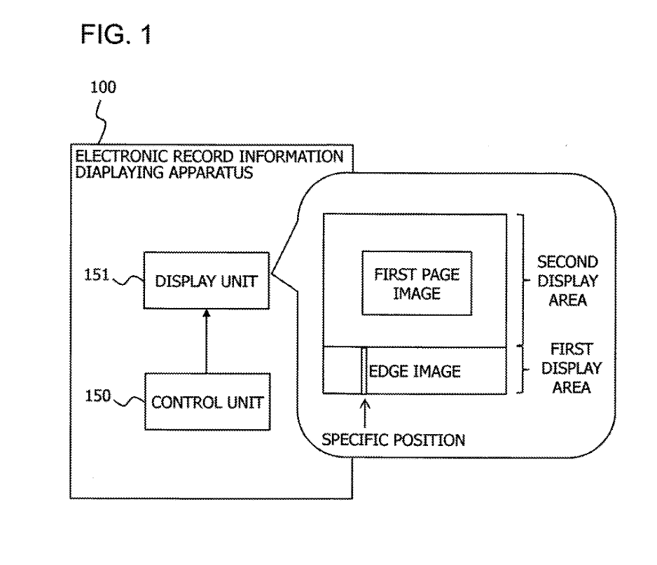

A first embodiment will be described. FIG. 1 illustrates a configuration example of an electronic record information displaying apparatus (which may hereafter be referred to as a “display apparatus”) 100 according to the first embodiment.

The display apparatus 100 includes a control unit 150 and a display unit 151.

The control unit 150 causes the display unit 151 to display a first display area and a second display area. Here, the first display area is, for example, an area for displaying an edge image associated with an edge of a document. Also, the second display area is an area for displaying, when a specific position to the edge image is designated, the image of a first page associated with the specific position.

The display unit 151 displays the edge image and the first page image on a display screen of the display unit 151, according to the control of the control unit 150, for example.

As such, according to the first embodiment, the edge image is displayed on the display unit 151. For example, there is a case when a user remembers the target page by a relative position of the document, like “that which I wrote around that part of the notebook”. If the user makes a search relying on such a vague memory, it is possible to execute the search on the basis of the edge image displayed on the display unit 151. Namely, because the relative position of a document is displayed in the edge image, it is possible to easily search for the location of “around that part”.

It may also be possible that the edge image is discriminatively displayed according to a feature of each page. In such a case, the user can also designate a specific position to an edge image in which a “page having a large number of graphics” is discriminatively displayed, like “a page after a page having a large number of graphics”, for example. Therefore, in this case also, it is possible to easily make a search.

The user can confirms electronic record information included in an image displayed on the second display area, so that can complete the search. Here, the electronic record information is, for example, information which is described in a document and electronically recordable in a memory etc. For example, a character, a graphic, a photograph, etc. may constitute electronic record information. The character, the graphic, the photograph, etc. displayed as a first page image are electronic record information, for example.

Therefore, the display apparatus 100 enables a user, when remembering information etc. vaguely, to easily search the electronic record information.

### Second Embodiment

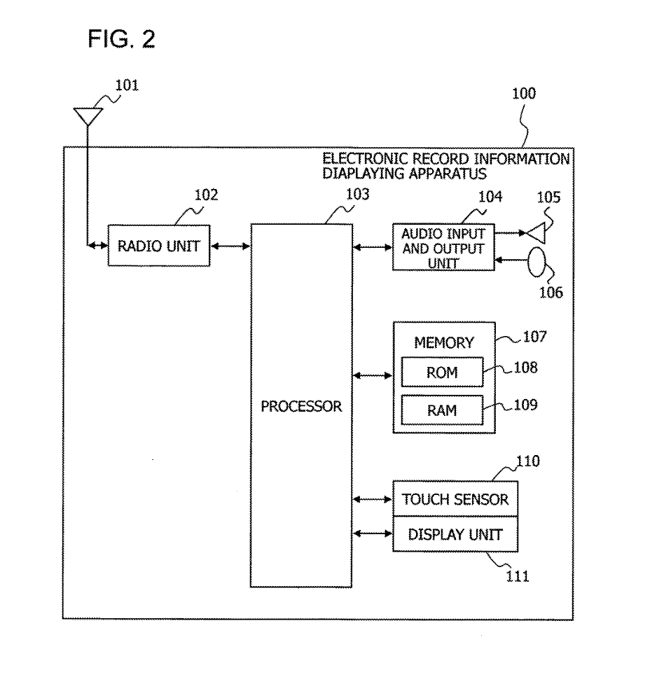

Next, a second embodiment will be described, FIG. 2 illustrates a configuration example of the display apparatus 100 according to the second embodiment.

<Configuration Example of Display Apparatus (Electronic Record Display Apparatus)>

The display apparatus 100 is, for example, a smart phone, a feature phone, a tablet terminal, a personal computer, a game apparatus, or the like. The display apparatus 100 is used as a handwriting notebook, for example. The display apparatus 100 can display electronic record information included in each page of the handwriting notebook.

Here, the electronic record information is, for example, information which is described in each page of a handwriting notebook and electronically recordable (or storable) in a memory 107. The electronic record information includes, for example, character, graphic, photograph, etc. which are included in each page of the handwriting notebook.

The display apparatus 100 includes an antenna 101, a radio unit 102, a processor 103, an audio input and output unit 104, a speaker 105, a microphone 106, the memory 107, a touch sensor 110 and a display unit 111. The memory 107 further includes a ROM (Read Only Memory) 108 and a RAM (Random Access Memory) 109.

Here, the control unit 150 in the first embodiment corresponds to the processor 103, for example. Also, the display unit 151 in the first embodiment corresponds to the display unit 111, for example.

The antenna 101 receives a radio signal transmitted from a base station apparatus, an access point, etc., and outputs the received radio signal to the radio unit 102. Also, the antenna 101 transmits a radio signal, output from the radio unit 102, to a base station apparatus, an access point, etc.

The radio unit 102 converts (downconverts) the radio signal received from the antenna 101 into a baseband signal, to output the converted baseband signal to the processor 103. The radio unit 102 also converts (upconverts) a baseband signal output from the processor 103 into a radio signal, to output the converted radio signal to the antenna 101.

The processor 103 controls the radio unit 102, the audio input and output unit 104, the memory 107, the touch sensor 110 and the display unit 111. The processor 103 reads out a program stored in the ROM 108, to load on the RAM 109 and execute the loaded program, so that can execute a variety of processing and functions in the display apparatus 100.

Such processing includes processing related to radio, for example. The processing related to radio includes the following, for example: The processor 103 executes demodulation processing on the baseband signal output from the radio unit 102, to extract voice data, character data, program data, etc. The processor 103 outputs the voice data to the audio input and output unit 104, outputs the character data to the memory 107 and the display unit 111, and outputs the program data to the memory 107, respectively. Further, the processor 103 may execute modulation processing on voice data output from the audio input and output unit 104, data output from the memory 107, etc. to convert into a baseband signal, so that may output the baseband signal to the radio unit 102.

Also, as the processing and the functions of the processor 103, there are handwriting notebook generation processing and electronic record information display processing included in each page of the handwriting notebook. The details will be described later in operation examples.

Additionally, the program may be stored in advance in the memory 107, for example, or may be downloaded from a base station apparatus and an access point through the antenna 101.

Also, the processor 103 may be a controller, a control unit, etc., for example, or in place of the processor 103, a CPU (Central Processing Unit), it is possible to apply an MPU (Micro Processing Unit), a DSP (Digital Signal Processor), an FPGA (Field-Programmable Gate Array) or the like.

The audio input and output unit 104 outputs the voice data received from the processor 103. The speaker 105 outputs a voice on the basis of the voice data.

The microphone 106 inputs a voice and converts the input voice into voice data, so as to output the voice data to the audio input and output unit 104. The audio input and output unit 104 outputs the voice data received from the microphone 106 to the processor 103.

The memory 107 stores a program, a variety of types of information, data, etc., for example. Also, the memory 107 stores each page of the handwriting notebook as image data, for example.

The handwriting notebook is one example of a document, for example. The document signifies, for example, information recorded on the premise of being referred to. The document includes, for example, a book, a newspaper, a magazine and an electronic book. Here, in the present second embodiment, the handwriting notebook represents a handwriting notebook in which information included in each page thereof can be stored in the memory 107, as electronic record information, for example.

The touch sensor 110 is a sensor which can switch on and off a switch when a person or a substance contacts thereto, for example. The touch sensor 110 is provided, for example, on the screen of the display unit 111. The touch sensor 110 detects an operation on the screen using, for example, an electromagnetic induction system, an electrostatic capacitance system, etc., so that can output the detection result to the processor 103.

The display unit 111 displays each page of the handwriting notebook, for example. Or, the display unit 111 displays electronic record information included in each page of the handwriting notebook, for example. At this time, the display unit 111 displays an edge image associated with an edge of the handwriting notebook.

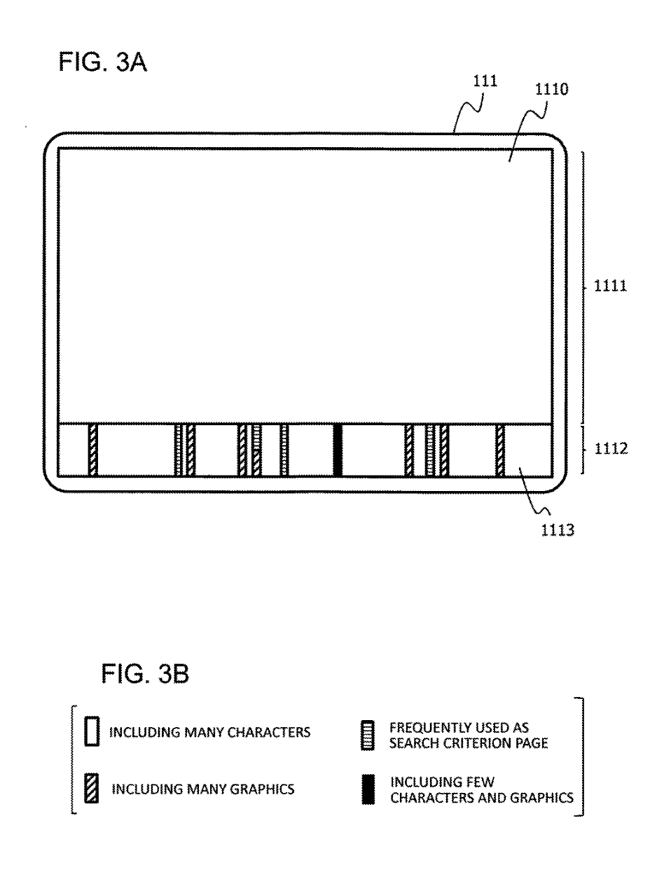

FIG. 3A illustrates an example of a display screen 1110 of the display unit 111. The display screen 1110 includes two display areas which are a preview display part 1111 and an edge UI (User Interface) display part 1112.

The edge UI display part 1112 is, for example, an area in which an edge image associated with an edge part of the document such as the handwriting notebook. The edge image displayed on the edge UI display part 1112 may be referred to as an edge UI 1113, for example.

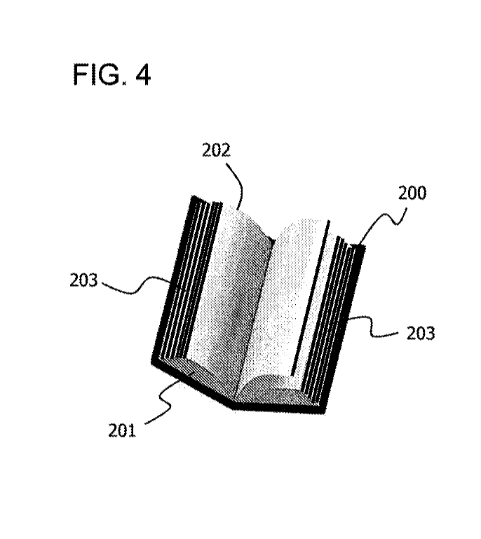

FIG. 4 illustrates an example of a book 200, as an example of a document. An edge denotes, for example, each cut surface 201, 202, 203 of the book 200. Here, in some cases, a cut surface 203 on the opposite side to the bound side in a spread state of the book 200 may be referred to as an edge of each page, for example.

Referring back to FIG. 3A, as to the edge UI 1113, for example, the handwriting notebook may be displayed in such a manner that each page count increases from the left side to the right side on the drawing, or vice versa.

According to the present second embodiment, each page which is identified according to a feature is displayed on the edge UI 1113. In the example of FIG. 3A, a page including “a large number of characters” is displayed with a blank frame, a page including “a large number of graphics” is displayed with oblique lines, and a “page including few characters and few graphics” is displayed in a filled black. Further, a “page to be used as a criterion for search” is displayed with lateral lines. FIG. 3B illustrates the examples of such features. When the user executes a tap operation on the edge UI 1113, a page image corresponding to the operation is displayed on the preview display part 1111. The details will be described later in operation examples.

Additionally, the discriminative display of each page on the edge UI 1113 depicted in FIG. 3A corresponds to the discriminative display of the edge part of the book depicted in FIG. 4. Therefore, when the user remembers relative positional relationship of the handwriting notebook, it is possible for the user to use the edge UI 1113 on the basis of the positional relationship.

Each feature of the page depicted in FIGS. 3A and 3B is one example. For example, the edge UI 1113 may include other features, such as “a large number of images”, “a large number of photographs”, etc. Or, a part of the feature examples depicted in FIG. 3B may be used. Also, each discriminative display may be color-coded by each color display according to the feature of each page.

Meanwhile, the preview display part 1111 displays the image of each page of the handwriting notebook, for example. In this case, the preview display part 1111 displays a page image corresponding to a user operation on the edge UI 1113. The details will be described in operation examples.

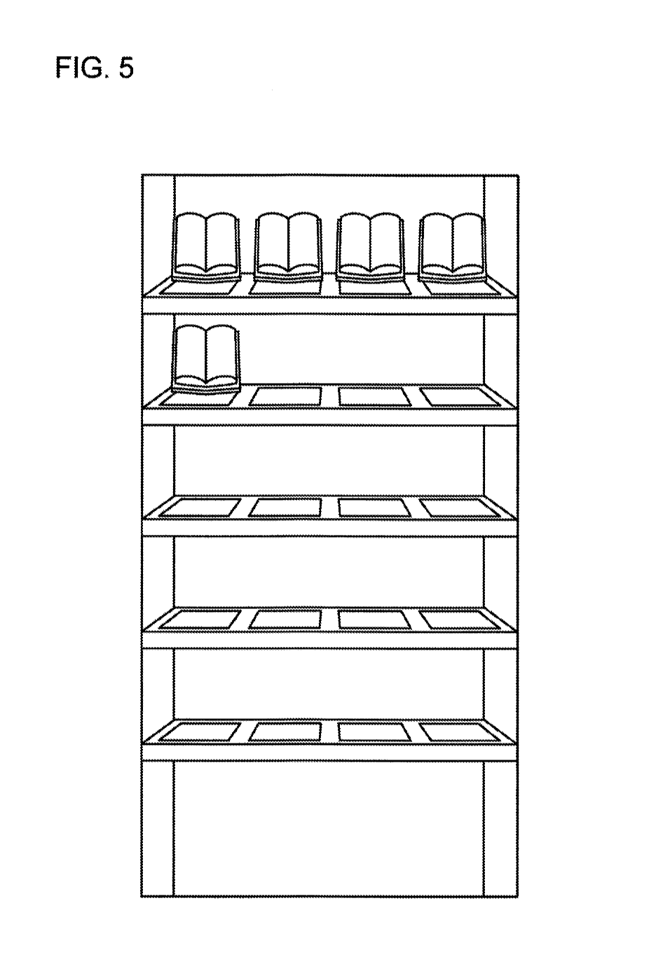

FIG. 5 illustrates a storage example of the handwriting notebook stored in the memory 107. For example, electronic record information is managed on the basis of each notebook, and a plurality of handwriting notebooks can be stored in the memory 107.

For example, the number of pages in each handwriting notebook may be fixed. The fixation of the number of pages produces the following three merits, for example.

First, in FIG. 3A, the scale of the edge UI 1113 becomes constant, and ease of use enables the user to easily discover a target page. For the user, the use convenience of the edge UI 1113 is improved.

Second, a vague memory of the user can be associated with the page position of the edge UI 1113. Also, the positional sensation of “around that part” can be fixed.

Third, using a visualized discriminative display on the edge UI 1113, it becomes possible to effectively utilize a vague memory at the time of search.

Additionally, in the present second embodiment, for example, the number of pages of each handwriting notebook may be fixed, or may be different dependent on each handwriting notebook.

### OPERATION EXAMPLES

Next, operation examples will be described. In the operation examples, descriptions will be given first on the generation processing of a handwriting notebook, and next, the display processing of the edge UI 1113, and finally, display processing corresponding to a user operation.

<1. Handwriting Notebook Generation Processing>

For example, the handwriting notebook is generated in the following manner. Namely, the display apparatus 100, on detection that a predetermined position of the display screen 1110 is tapped, displays an edition screen of the handwriting notebook. The user inputs a character, a graphic, a photograph, etc. on the edition screen to generate the handwriting notebook. The display apparatus 100 manages the generated handwriting notebook on a page-by-page basis, and converts each page of the generated handwriting notebook into image data. The display apparatus 100 then stores the image data into the memory 107. The image data in each page includes information of the character, the graphic, the photograph, etc. which are input by the user. The character, the graphic, the photograph, etc. come to electronic record information, for example. Such processing may be executed by the processor 103, for example.

<2. Edge UI Display Processing>

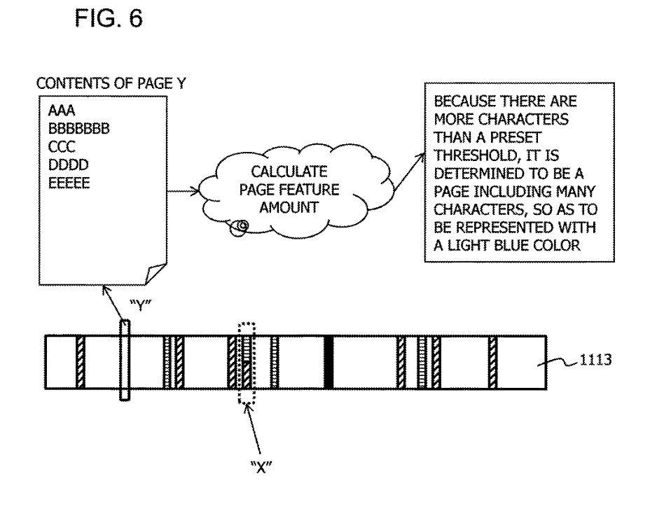

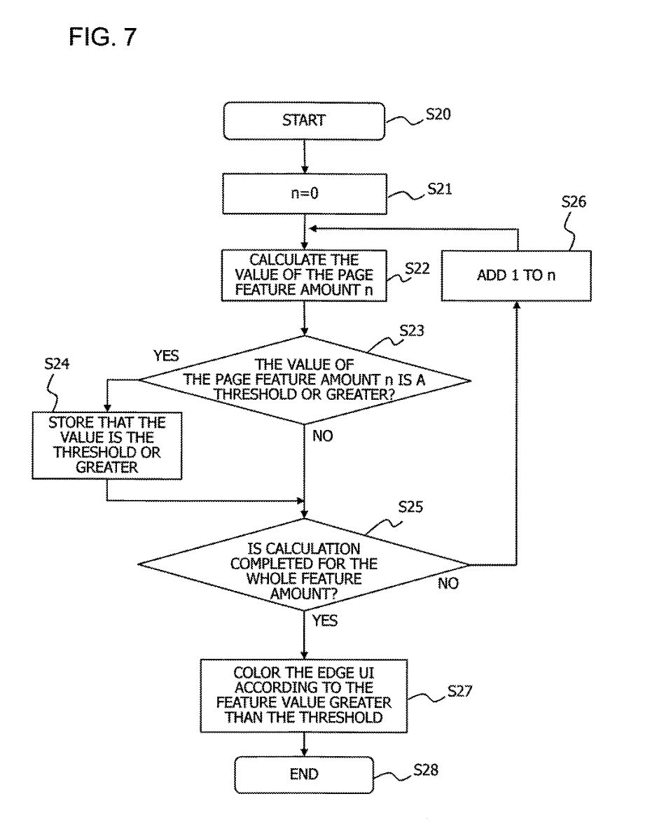

Next, the edge UI display processing will be described. FIG. 6 illustrates an example of the display processing of the edge UI 1113. Also, FIG. 7 is a flowchart illustrating an operation example of the display processing.

As depicted in FIG. 6, the display apparatus 100 calculates a “value” of a feature amount in regard to the quantity of characters, the quantity of graphics, the number of times used as a search criterion page, etc. on a feature-by-feature basis for each handwriting notebook page. The display apparatus 100 then discriminatively displays each page according to the “value” of the feature amount.

As to the discriminative display on the edge UI 1113, the length and the width of the display are not changed by the magnitude of frequency of each page or the magnitude of a data amount, for example, and instead may be divided at equal intervals for each page. Also, as depicted in page “X” of FIG. 6, two discriminative displays may be given to an identical page if the page includes a large number of graphics and also is used as a search criterion page. As such, when there is a plurality of features in one page, an area for displaying the one page may be divided at equal intervals to make a discriminative display.

In the example of FIG. 6, after calculating the value of the feature amount of a page Y, the display apparatus 100 discriminates that the page Y to be a “page including a large number of characters” because the value of the feature amount is larger than a threshold predetermined for character, so as to cause to display the page of interest with a “light blue color”.

FIG. 7 is a flowchart illustrating an example of the display operation of the edge UI 1113. The flowchart depicted in FIG. 7 is processing executed by the processor 103, for example. Here, the display apparatus 100 may execute the flowchart as depicted in FIG. 7 whenever a page is updated, for the updated page. Alternatively, the display apparatus 100 may execute the flowchart as depicted in FIG. 7 page-by-page at each predetermined time interval for all handwriting notebook pages.

The display apparatus 100, on starting the display processing (S20), substitutes “0” for n (S21), and calculates the value of a page feature amount n (S22).

Here, n represents a feature amount such as “the quantity of characters”, “the quantity of graphics”, “the quantity of search times”, etc. For example, n=0 signifies “the quantity of characters”, n=1 signifies “the quantity of graphics”, n=2 signifies “the quantity of search times”, or the like. The display apparatus 100 calculates the “value” of each feature amount n, for example.

For example, the display apparatus 100 calculates the value of the feature amount n for “the quantity of characters” (for example, a feature amount n=0) in the following manner. Namely, the display apparatus 100 discriminates the presence or absence of an object, such as a character, a graphic and an image, in a page on the basis of the pixel value of each pixel in the image data of a processing target page. On discriminating the presence of an object, the display apparatus 100 compares the object of interest with each character in a character database stored in the memory 107, to discriminate the degree of coincidence. When the degree of coincidence is equal to or greater than a threshold for coincidence, the display apparatus 100 discriminates that the object is a character. The display apparatus 100 then counts the number of discriminated characters in the page, and determines the count value to be the value of the feature amount n related to character.

For example, the display apparatus 100 calculates the value of the feature amount n related to a graphic (for example, n=1) in the following manner. Namely, in the calculation step of the value of the feature amount n related to character, if the degree of coincidence is smaller than the threshold for coincidence, the display apparatus 100 discriminates that the object is a graphic. The display apparatus 100 then counts the number of times discriminated to be a graphic in the page, and determines the count value to be the value of the feature amount n related to graphic.

For example, the display apparatus 100 calculates the value of the feature amount n related to the number of times searched as a criterion page (for example, n=2) in the following manner. Namely, the display apparatus 100 counts the number of search times for the page of interest, and determines the count value to be the value of the feature amount n related to the number of search times.

In the above-mentioned manner, for example, the display apparatus 100 calculates each value of the feature amount, such as the quantity of characters and graphics included in the page, the number of search times for the page, and the quantity of images.

The above-mentioned calculation method for the value of the feature amount n is an example. To calculate the value of the feature amount n, including discriminating an object, a variety of methods including a well-known method are applicable.

Next, the display apparatus 100 discriminates whether or not the value of the feature amount n is a threshold or greater (S23). For example, the threshold may be different according to the feature amount n, or may be identical. For example, a threshold for character, a threshold for graphic and a threshold for the number of search times may be different from one another, all identical or a partially identical. For example, when the feature amount n is “0”, the display apparatus 100 discriminates whether or not the value of the feature amount n of character is the threshold for character or greater.

If the value of the feature amount n is the threshold or greater (YES in S23), the display apparatus 100 stores into the memory 107 an indication that the value is the threshold or greater (S24). For example, if the value of the feature amount n for character is the threshold for character or greater, the display apparatus 100 stores an indication thereof into a predetermined area of the memory 107.

Then, the process of the display apparatus 100 shifts S25.

On the other hand, if the value of the feature amount n is smaller than the threshold (NO in S23), the process of the display apparatus 100 also shifts S25.

In S25, the display apparatus 100 discriminates whether or not the calculation of the whole feature amount for the feature amount n is completed. For example, the display apparatus 100 may add “1” to n, to perform discrimination based on whether or not n after addition exceeds the number of articles of the feature amount. In the above-mentioned example, the number of articles of the feature amount is “3”, that is, the character, the graphic and the number of search times, for example.

If the calculation of the whole feature amount is not completed (NO in S25), the display apparatus 100 adds “1” to n (S26), and shifts to the processing of S22. In this case, the display apparatus 100 repeats the above-mentioned processing for the next feature amount n. For example, the display apparatus 100 sets n=1 to perform processing from S22 to S25 for the value of the feature amount n for graphic. The display apparatus 100 repeats such processing as above for the whole feature amount n, to calculate all values of the feature amount n.

On the other hand, when the calculation of the whole feature amount is completed (YES in S25), the display apparatus 100 performs processing to color the edge UI 1113 according to the feature of the threshold or greater (S27).

For example, the display apparatus 100 may perform coloring processing as described below. Namely, the display apparatus 100 performs coloring processing on the basis of information indicative of being greater than and including the threshold stored in S24. The display apparatus 100 may color with “light blue” when the value of the feature amount n for character is greater than and inclusive of the threshold for character, and color with “green” when the value of the feature amount n for graphic is greater than and inclusive of the threshold for graphic, and so on. Also, for example, the display apparatus 100 may color with “brown” when the value of the feature amount n for the number of search times is greater than and inclusive of the threshold for the number of search times, and so on. The display apparatus 100 then generates image data corresponding to color-coding to store into the memory 107. Further, the display apparatus 100 generates such image data for all handwriting notebook pages, so that can generate image data for an edge image. The edge image thus generated corresponds to the edge UI 1113. The processor 103 reads out the image data stored in the memory 107 to output to the display unit 111, so that can display the edge UI 1113 on the edge UI display part 1112.

Here, the above example of coloring is one example, and any coloring is applicable as long as the feature of each page can be identified by colors. Also, in place of the coloring, an oblique hatch, a blank frame, etc. are applicable as depicted in FIG. 3A, as long as the feature of each page can be identified. Further, as to a processing target page, when all of a plurality of values of the feature amount n is greater than and inclusive of the thresholds for the plurality of articles of the feature amount n, an area for one page in the edge UI 1113 may be divided equally and color-coded. For example, the above case corresponds to a case of a page including a large number of graphics and also a large number of times used as a search criterion page, as depicted in FIG. 3A. Alternatively, as to a processing target page, if the value of the feature amount for a certain feature is smaller than the threshold, the display apparatus 100 may perform coloring processing etc. for the page. For example, the display apparatus 100 may color a page in which the value of the feature amount n for character is smaller than the threshold for character, or may color a page in which the value of the feature amount n for graphic is smaller than the threshold for graphic, in a manner that a feature can be discriminated from another. In this case also, if the value of the feature amount n for character is smaller than the threshold for character, and also the value of the feature amount n for graphic is smaller than the threshold for graphic, the display apparatus 100 may perform coloring in a manner that a feature can be discriminated from another, for example. In FIG. 3A, a display example in the above case is depicted.

As such, the display apparatus 100 may display the processing target page in such a manner that, according to the value of the feature amount n, the feature can be discriminated from other pages, for example.

<3. Display Processing Corresponding to User Operation>

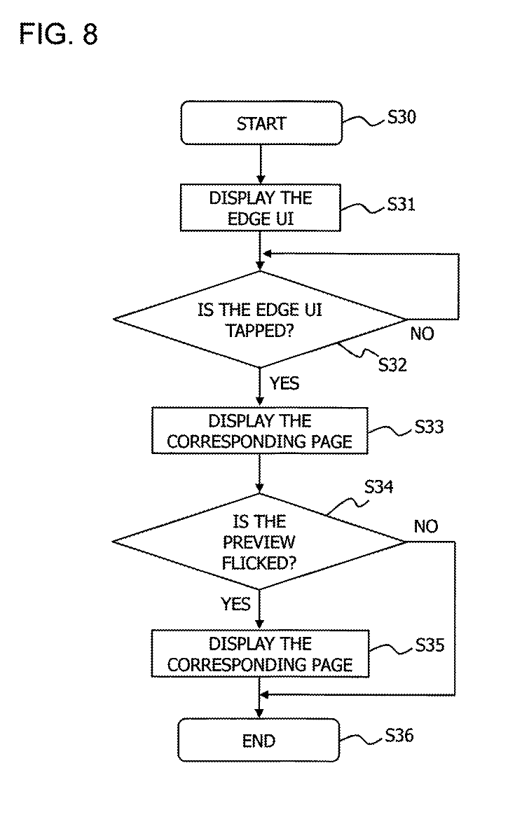

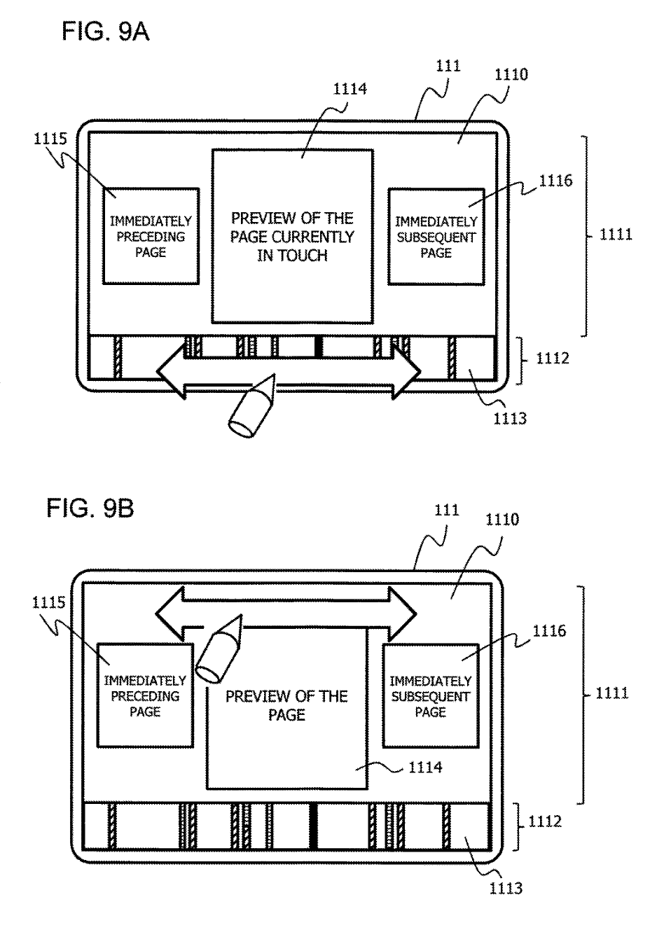

FIG. 8 illustrates a flowchart illustrating an example of display operation corresponding to a user operation. FIGS. 9A and 9B illustrate each example of a display screen 1110. The flowchart depicted in FIG. 8 is processing executed in the processor 103 of the display apparatus 100, for example.

As depicted in FIG. 8, the display apparatus 100, on starting processing (S30), causes to display the edge UI 1113 on the display screen 1110 of the display unit 111 (S31). For example, the display apparatus 100 may execute processing as depicted in FIG. 7, to cause to display the edge UI 1113.

Next, the display apparatus 100 discriminates whether or not a specific position of the edge UI 1113 is tapped (S32).

For example, the display apparatus 100 performs such processing as described below. Namely, there is provided a touch sensor 110 in an area of the edge UI display part 1112 of the display screen 1110. The touch sensor 110 detects the action of a user operation on the edge UI 1113 on the basis of an operation position, an operation direction, a contact time, etc. on the display screen 1110, to notify the processor 103 of the detection result. Based on the detection result, the processor 103 discriminates whether or not the edge UI 1113 is touched.

The display apparatus 100 waits until a specific position of the edge UI 1113 is tapped (NO in S32), and when the specific position of the edge UI 1113 is tapped (YES in S32), displays the target page (S33).

FIG. 9A illustrates an example of the display screen 1110 when the edge UI 1113 is tapped. In the above example, an example when the user taps the edge UI 1113 using a dedicated pen is depicted. On the preview display part 1111, there is displayed a preview image 1114 of a page of which edge UI 1113 is tapped with the dedicated pen. In this case, the preview image 1114 is displayed at the center of the preview display part 1111, and on the left side thereof on the drawing, a preview image 1115 of the immediately preceding page to the preview image 1114 is displayed. Also, on the right side of the preview image 1114 on the drawing, a preview image 1116 of the immediately subsequent page to the preview image 1114 is displayed. The preview image 1114 at the center is displayed larger than the left and right preview images 1115, 1116.

For example, the display apparatus 100 performs the following processing: The image data of each page is stored in the memory 107. Based on the detection result from the touch sensor 110, the processor 103 reads out each image data of the target page and pages immediately before and after the target page, and outputs the readout image data to the display unit 111. In this case, the processor 103 may instruct the display unit 111 to display an image which corresponds to the image data of the target page in a manner to be larger than the images of the other pages. By this, as depicted in FIG. 9A, for example, the target page image is displayed at the center of the preview display part 1111, whereas the respective preview images 1115, 1116 of the pages immediately before and after the target page are displayed on the left and right of the preview image 1114.

Here, as depicted in FIG. 9A, when a flick operation to the left or right is given to the edge UI 1113, the preview image 1114 of a corresponding page is scroll-displayed. In this case also, for example, based on the detection result from the touch sensor 110, the processor 103 may successively read out the image data of the page corresponding to the detection result from the memory 107, to output to the display unit 111 to scroll-display.

Referring back to FIG. 8, next, the display apparatus 100 discriminates whether or not a flick operation is performed on the preview display part 1111 (S34). Then, if a flick operation is performed on the preview display part 1111 (YES in S34), the display apparatus 100 displays the target page (S35).

FIG. 9B illustrates an example of the display screen 1110 when a flick operation is performed on the preview display part 1111. On the display apparatus 100, an operation can also be given to the preview display part 1111, so that preview images 1114-1116 are scroll-displayed according to the operation.

For example, the display apparatus 100 performs the following processing: The touch sensor 110 detects an operation on the preview display part 1111, to notify the processor 103 of the detection result. Based on the detection result, the processor 103 successively reads out image data corresponding to the detection result from the memory 107, to output the readout image data to the display unit 111. This causes the scroll display of an image corresponding to the flick operation on the preview display part 1111, for example.

Referring back to FIG. 8, the display apparatus 100 displays the target page (S35), and then completes a series of processing (S36).

When a flick operation is not given to the preview display part 1111 (S34), the display apparatus 100 completes a series of processing also (S36). In this case, it comes to a state that the page displayed in S33 is left displayed on the preview display part 1111.

For example, there is a case that the user remembers the target page and information described in the target page as a vague memory with the sense of “around that part” such as “that which I wrote around that part of the notebook”, “that which I wrote slightly after that page of the notebook”, and the like. For example, there is considered a case when the user remembers information which is described on a page following “a page having a large number of graphics”.

In this case, for example, as depicted in FIG. 3A, each page having “a large number of graphics” is depicted on the edge UI 1113. As depicted in FIG. 9A, when the user taps the edge UI 1113 of the corresponding page, the preview image 1116 of a page following the preview image 1114 of the corresponding page of concern is displayed on the preview display part 1111. Then, a flick of the preview display part 1111 by the user enables the display of the preview image 1114 of the target page at the center of the preview display part 1111. Accordingly, even in the case of such a user who vaguely remembers information, the display apparatus 100 enables the user to easily search electronic record information included in the target page.

However, there is a case when the user remembers information incorrectly. For example, there is a case that the preview image 1116 tapped as a page including “a large number of graphics” is different from his memory, and the like. In this case also, if a plurality of pages which include “a large number of graphics” is discriminatively displayed on the edge UI 1113, the user can search another page which includes “a large number of graphics”. If the user operates the edge UI 1113 to confirm a preview image 1116 of another page which includes “a large number of graphics”, the user may discover the target page (or electronic record information included in the target page) which is coincident with a vague memory of his own.

As such, the edge UI 1113 according to the present second embodiment enables the user to easily grasp at a glance a characteristic page which the user strongly remembers. Therefore, as compared with a case when the user performs a search at random, the display apparatus 100 enables the user to perform an efficient search through a simple operation. Accordingly, the display apparatus 100 enables an easy search of electronic record information if the user searches relying on a vague memory.

Additionally, the tap operation (S32) and the flick operation (S34) in FIG. 8 are merely examples. Other operations including, for example, a scroll operation, a swipe operation, etc. may be applicable for the operations in the processing (S22, S34).

### Other Embodiments

Next, other embodiments will be described.

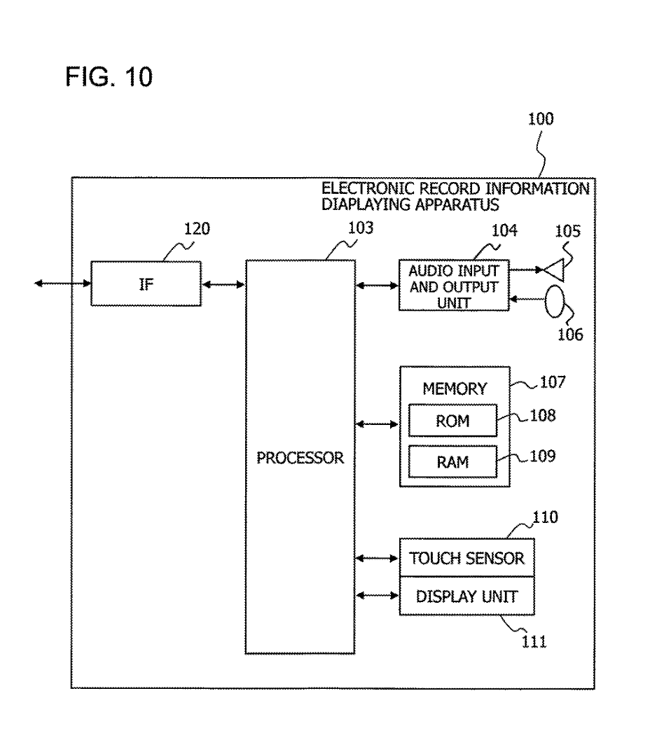

In the second embodiment, the description is given using an exemplary case such that the display apparatus 100 can perform radio communication, as depicted in FIG. 2, for example. FIG. 10 illustrates an example of another display apparatus 100. The display apparatus 100 depicted in FIG. 10 further includes an IF (Interface) 120. The IF 120 is connected to a wired network such as the Internet. The IF 120 is configured to be able to convert data received from a processor 103 etc. into packet data of a format transmittable to the wired network and transmit, under the control of the processor 103, for example. Also, under the control of the processor 103 for example, the IF 120, on receiving the packet data, may extract data etc. from the packet data, to output to the processor 103. Such a display apparatus 100 includes a personal computer etc., for example. The display apparatus 100 can download a program through the IF 120, for example. In this case, the display apparatus 100 stores the downloaded program into a memory 107 etc. to execute the stored program, so that can execute the processing described in the second embodiment etc.

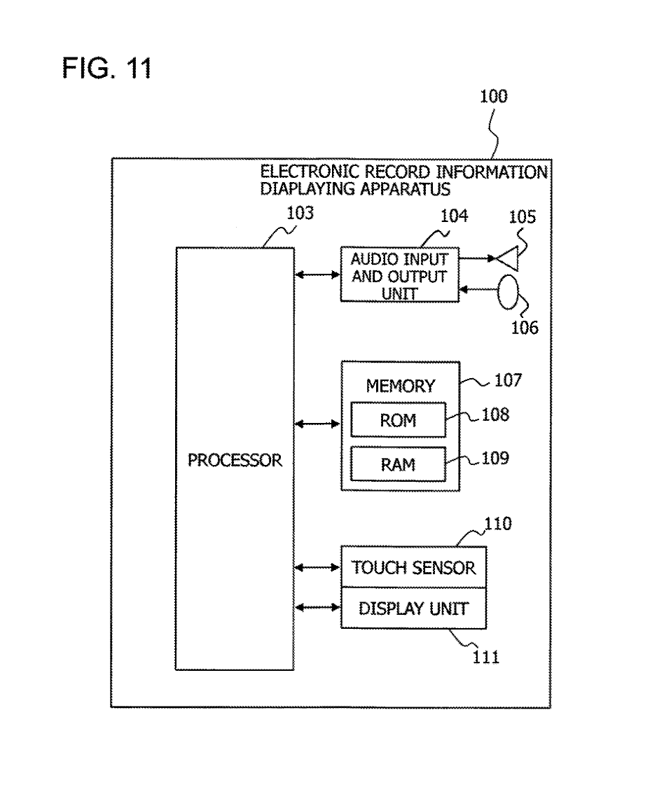

For example, as depicted in FIG. 11, it may also be possible to provide the display apparatus 100 which does not include a communication function. In this case also, the processor 103 executes a program stored in a ROM 108, so that can execute the processing described in the second embodiment, etc.

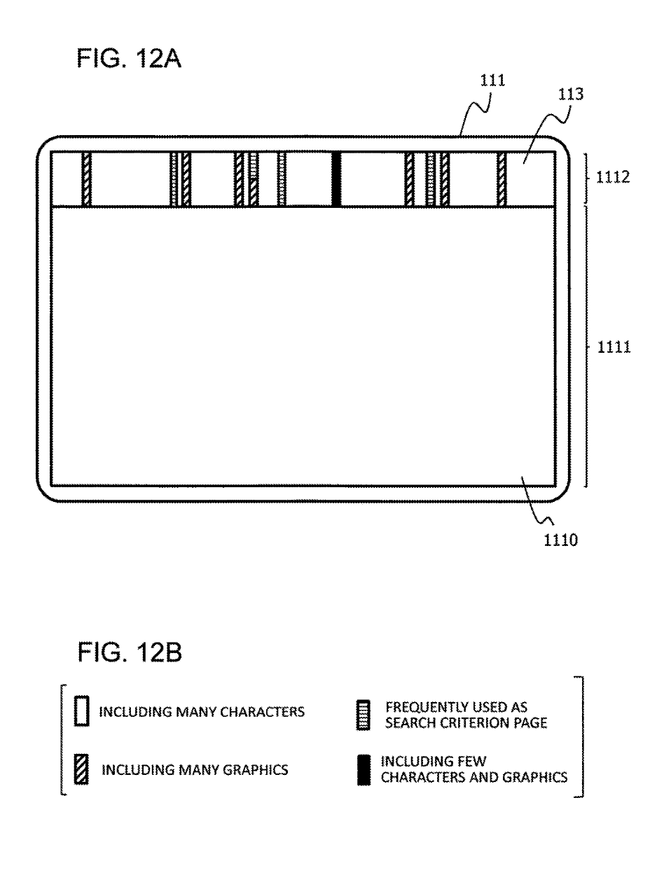

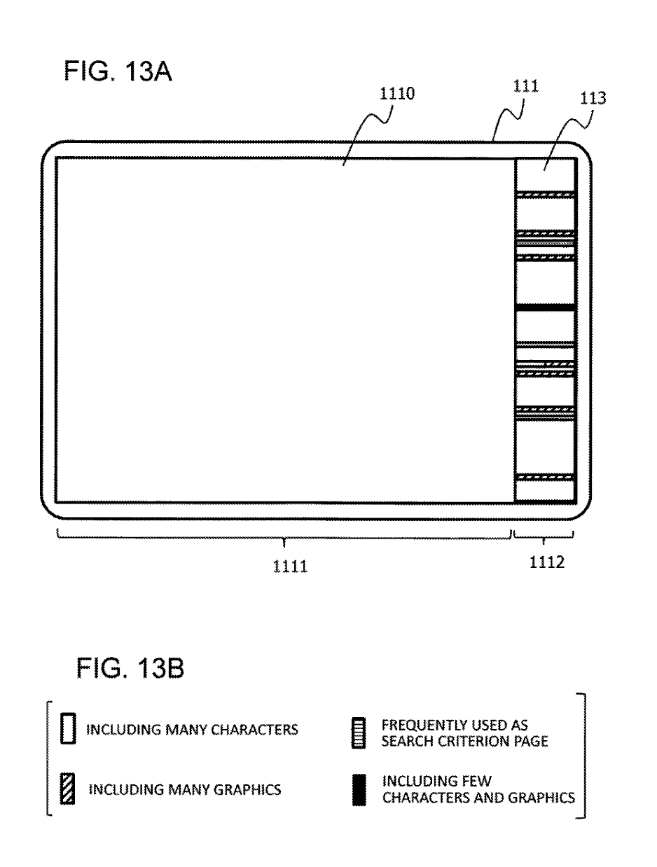

In the example described in the aforementioned second embodiment, as depicted in FIG. 3A for example, the edge UI 1113 is displayed at a lower part of the display screen 1110. For example, the edge UI 1113 may be displayed on an upper part of the display screen 1110 as depicted in FIG. 12A, or may be displayed on the right side of the display screen 1110, as depicted in FIG. 13A. Alternatively, the edge UI 1113 may be displayed on the left side of the display screen 1110, or may be displayed in a partial area of the display screen 1110. FIGS. 12B and 13B illustrate each example of the feature of the edge UI 1113.

Further, in the aforementioned second embodiment, the description is given taking the handwriting notebook as an example of the document. For example, the document may be other documents than the handwriting notebook, such as an electronic book and an electronic magazine.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An electronic record information displaying apparatus comprising:
a display unit; and
a control unit configured to cause the display unit to display a first display area that displays an edge image corresponding to an edge of document and a second display area that displays an image of a first page corresponding to a specific position designated to the edge image.

2. The electronic record information displaying apparatus according to claim 1, wherein
the control unit is configured to cause to display in the first display area the image of the first page, an image of a second page of immediately preceding page to the first page, and an image of a third page of immediately subsequent page to the first page.

3. The electronic record information displaying apparatus according to claim 2, wherein
the control unit is configured to cause to display the image of the first page larger than the images of the second and third pages.

4. The electronic record information displaying apparatus according to claim 1, wherein
a first electronic record information included in the first page is included in the image of the first page displayed in the second display area.

5. The electronic record information displaying apparatus according to claim 2, wherein
a second and third electronic record information included in the second and third pages respectively is included in the images of the second and third pages respectively.

6. The electronic record information displaying apparatus according to claim 1, wherein
the control unit is configured to cause to display in the first display the edge image where each page is identified according to a feature.

7. The electronic record information displaying apparatus according to claim 1, wherein
the control unit is configured to cause to display in the first display area the edge image where each page is identified according to an amount of character included in a page, an amount of graphic included in the page, search times of the page, or an amount of an image.

8. A non-transitory computer-readable recording medium having stored therein an electronic record information displaying program that causes a computer including a display unit to execute a process comprising:
causing the display unit to display a first display area that displays an edge image corresponding to an edge of document and a second display area that displays an image of a first page corresponding to a specific position designated to the edge image.

9. An electronic record information displaying method in an electronic record information displaying apparatus including a display unit and a control unit, the method comprising:
causing the display unit to display a first display area that displays an edge image corresponding to an edge of document and a second display area that displays an image of a first page corresponding to a specific position designated to the edge image, by the control unit.
